(19) United States
(12) Patent Application Publication
(10) Pub. No.: US 2003/0121011 A1
(43) Pub. Date: Jun. 26, 2003

(54) Functional coverage analysis systems and methods for verification test suites

(75) Inventor: Hamilton B. Carter, Austin, TX (US)

Correspondence Address: CIRRUS LOGIC, INC., CIRRUS LOGIC LEGAL DEPARTMENT, 2901 VIA FORTUNA, AUSTIN, TX, 78746, US

(73) Assignee: Cirrus Logic, Inc., Fremont, CA

(21) Appl. No.: 10/352,591

(22) Filed: Jan. 28, 2003

Related U.S. Application Data
(62) Division of application No. 09/345,171, filed on Jun. 30, 1999.

(51) Int. Cl. G06F 17/50

(52) U.S. Cl. 716/4

(57) ABSTRACT

Coverage metrics are expressed with an intuitive graphical interface based upon data flow. Coverage analysis and presentation objects are integrated to produce coverage results which enable device functionality in a device under test to be modeled as objects, subject to event occurrence. Event objects are introspected at run-time, allowing the user to determine the event object's attributes with specification of coverage metrics subject to a selected combination of the event object's attributes. The event objects are serialized into permanent storage, allowing the user to specify and execute new coverage metrics at any time after simulation. Operations used to describe coverage metrics are modeled as analysis objects. Such analysis objects accept event objects as inputs, using a predetermined, well-defined interface. The combination of event objects and analysis objects allows coverage metrics to be specified in a simple data flow manner. With such a coverage metric, the user attaches or wires (metaphorically) the analysis objects together in a visual builder environment. Using the analysis objects, the user specifies desired coverage metrics, such as coverage of sequences of events and/or coverage of events that occur during the same time window of a simulation. The display functionality of the coverage tool is expandable because the presentation objects use the same event object interface as the analysis operator objects. Coverage metrics are subject to specification either before or after event occurrence. The user specifies coverage metrics using an intuitive graphical interface based upon data flow, without any specific programming language skills being necessary. Functional events in the device under test are treated as event objects. Each event object may be passed to selected analysis tools chosen by the user, such as analyzers, logic gates, and coincidence counters.

### CROSS-REFERENCE TO RELATED PATENT APPLICATIONS

This patent application is related to the following additional patent applications which are hereby expressly referenced and incorporated hereinto in their entirety by reference: patent application Ser. No. ______, patent application Ser. No. ______ and patent application Ser. No. ______, having respective titles “Systems And Methods For Generating Interchangable Device Event Description Databases For Use in a Functional Coverage Tool That Is Portable Between Designs”, “Systems And Methods For Manipulating Configuration Events in a Dataflow Functional Coverage Tool For a Verification Test Suite”, and “Systems and Methods for Allowing Graphical User Connection of Coverage Analyzer Operators in a Data Flow Functional Coverage Tool”, with the same filing date as the present patent application, and the same inventorship.

### BACKGROUND OF THE INVENTION

1. Field of the Invention

This application relates to digital design methods and systems and more particularly to methods and systems for gauging the completeness of simulation test suites for digital design operations.

2. Description of Related Art

A substantial portion of the digital semiconductor development cycle is devoted to pre-production verification. With increasingly complex circuits, it is more and more difficult to gauge when verification should be considered to be completed. Verification completeness is subject to assessment by measuring the amount of coverage provided by test suites run against a particular design. A number of tools now perform this daunting task. Currently, these tools include code coverage tools and functional coverage tools. Code coverage tools describe little about the device functionality. The code in an HDL description can be executed without simulation of substantial device functional features. Accordingly, only a coarse measure of test suite effectiveness is provided with the HDL description code. On the other side, while functional test tools provide a more complete view of the coverage of the actual device functionality, at present the functional tools are primitive and limited in many ways. The tool output in particular instances is no more than a simple bar graph of predetermined event counters. Further, particular tools require the user either to instrument the entire HDL description of the device under test, at a considerable risk of error, or to write coverage code in a separate language, which on occasion is non-intuitive and significantly time intensive. One current tool containing a relational data base for analysis of event traces originating from a particular simulation resulted in each recorded event in the device under test being stored as a row in a database table. Thus, the user is forced to evaluate device events through a database oriented filter utilizing, in one instance, an SQL query language process. As a result, the user is limited in coverage ability by the limitations of SQL and the user familiarity with the language. In any case, the use of the SQL tool is limited to post-processing of information.

Gauging the completeness of simulation test suites for digital designs is further a difficult technical and practical task. Current tools that measure the coverage provided by a particular test suite have proven inadequate for a variety of reasons. In particular, current code coverage tools do not accurately measure the amount of device functionality exercised. For example, HDL code lines executed do not correlate directly to functionality exercised. In some instances, current functional coverage tools are programmed with specific coverage metrics prior to simulation and are effective merely for providing simple counts of activity and simplistic bar graph outputs. New coverage metrics then require the user to reprogram and rerun the simulation. Further, some functional coverage tools currently do not allow post simulation specification of coverage metrics. In some tools, the user is required to know a specialized query language which is unsuited for describing desired coverage metrics. Accordingly, it is desirable to develop new coverage tool methodologies and systems which overcome the shortcomings of currently available tools.

### SUMMARY OF THE INVENTION

According to one embodiment of the present invention, coverage metrics are subject to user specification before or after simulation operation. Further, the coverage metrics are subject to user specification with an intuitive graphical interface based upon data flow, without specific or arcane program language knowledge being required for implementation. According to the present invention, additional coverage analysis and presentation objects are conveniently integrated into an expanded system functionality. No original system modifications are required for the implemented expansions. Further, instrumentation of device under test hardware design language code is not required for operation according to the present invention. Additionally, according to the present invention, coverage results are provided which enable device functionality to be understood. In particular under the present invention, events in a device under test are modeled as objects. Each event object has a name and a number of attributes that describe the event. The event objects are introspected at run-time, allowing the user to determine the event object's attributes with specification of coverage metrics subject to a selected combination of the event object's attributes. The event objects are serialized according to one embodiment of the present invention, to permanent storage, allowing the user to specify and execute new coverage metrics at any time after simulation. Operations used to describe coverage metrics are modeled as analysis objects according to the present invention. Such analysis objects accept event objects as inputs, using a predetermined, well-defined interface. The combination of event objects and analysis objects according to the present invention allows coverage metrics to be specified in a simple data flow manner. Event objects are particularly treated as a data stream that is operated on by predetermined analysis objects. The analysis objects are modeled after user-familiar objects such as for example, comparators, logic gates, counters, and analyzers. With such a coverage metric, the user attaches or wires (metaphorically) the analysis objects together in a visual builder environment according to the present invention. Using the analysis objects, the user specifies desired coverage metrics which would otherwise be difficult or impossible otherwise to implement, such as coverage of sequences of events and/or coverage of events that occur during the same time window of a simulation. Because analysis objects accept and pass on event objects through a standardized interface, the addition of new analysis objects can be accomplished without modification of the coverage tool utilized. The resulting output of specialized coverage metrics is displayed with a special class of analysis objects known currently as presentation objects. The display functionality of the coverage tool is expandable because the presentation objects use the same event object interface as the analysis operator objects. Analysis objects and their interconnections are serialized into selected storage locations according to the present invention, permitting the user to save desired coverage metrics and to enable measurement of the completeness of future test suites. Further according to the present invention, coverage metrics are subject to specification either before or after device simulation occurrence. Additionally, the user specifies coverage metrics using an intuitive graphical interface based upon data flow, without any specific programming language skills being necessary. Moreover, the system according to the present invention is easily expandable, by adding new coverage analysis and presentation objects. Such expansions require no original system alterations. Implementation according to the present invention is architecturally independent, meaning that a change in a device under test does not require a change in the coverage tool. According to the present invention, the functional behavior of a given device under test is described in a series of functional events which indicate that a particular occurrence has transpired within the device in which a functional portion of the device has been exercised, and which indicate what the settings of the device related to a particular functionality were when the event occurred. According to the present invention, functional events in the device are treated as event objects. Each functional event according to the present invention has a name and zero or more attributes with which it is associated. An example functional event according to the present invention is a bus cycle on a digital device. For a bus cycle event example attributes are read or write type, simulation time at initiation, bus cycle address, and data transferred by cycle operation. The system according to the present invention is versatile and intuitive as a coverage tool in that it treats device events detected as an independent object with name and attributes. Each event object may be passed to selected analysis tools chosen by the user, such as analyzers, logic gates, and coincidence counters. According to one embodiment of the present invention, event objects are created by functions added to the original HDL code describing the device under test, despite possibility of errors and vulnerability to device architecture changes. Such a device change requires code adaptation. According to another embodiment of the present invention, a functional model of the device under test is constructed to verify the device behavior and to produce functional event objects. The functional model according to the present invention accordingly receives the states of inputs and outputs to the device and the modeled behavior determines when device output events occur in a simulation. The functional model creates an event object and serializes it to selected storage, without any necessity to instrument HDL files describing the device. The coverage of a selected test suite is thus capable of analysis for functional coverage, simply, intuitively, and powerfully, as well as dynamically at runtime by specification of coverage metrics. The invention also has an extensible architecture that allows the expansion of the tool without core system modifications. The tool according to the present invention is independent of the device under test, allowing it to be used for selected digital designs according to user selection. According to one embodiment, the tool of the present invention is unaffected by changes in the underlying device under test that do not directly change the functionality of the device, such as when architectural changes are made to enhance performance of the device under test, such as for example net name changes.

### BRIEF DESCRIPTION OF THE DRAWINGS

FIG. 1 is a block diagram of the architecture of a generalized wiring system for a data flow functional coverage tool, according to the present invention;

FIG. 2 is a block diagram of a graphical user interface, including a toolbar and a specification area, according to one embodiment of the present invention;

FIG. 3 is a block diagram of a particular test environment, according to the present invention;

FIG. 4 is a block diagram of a test environment having a selected device under test (DUT) within a simulation domain, and further including a coverage tool and a storage mechanism in a verification environment in communication with the simulation domain, according to another embodiment of the present invention;

FIG. 5 is a data flow diagram describing operation of a coverage tool method, according to one embodiment of the present invention;

FIG. 6 is a block diagram of an EventInfo object architecture according to the present invention;

FIG. 7 is a block diagram of an analysis object used to define coverage metrics to be executed on the event object stream created by a given simulation or set of simulations, according to one embodiment of the present invention;

FIG. 8 is a diagram of a registration step of event transmission, according to the present invention, operating in first and second domains, a user interface domain and an associated functional domain;

FIG. 9 is a diagram of a request storage step of event transmission according to the present invention;

FIG. 10 is a diagram of an event object transmission step with respect to event transmission operation 120 according to the present invention; and

FIG. 11 is a block diagram of a computer system for implementing operation of a computer program product according to the present invention.

### DETAILED DESCRIPTION OF A PREFERRED MODE

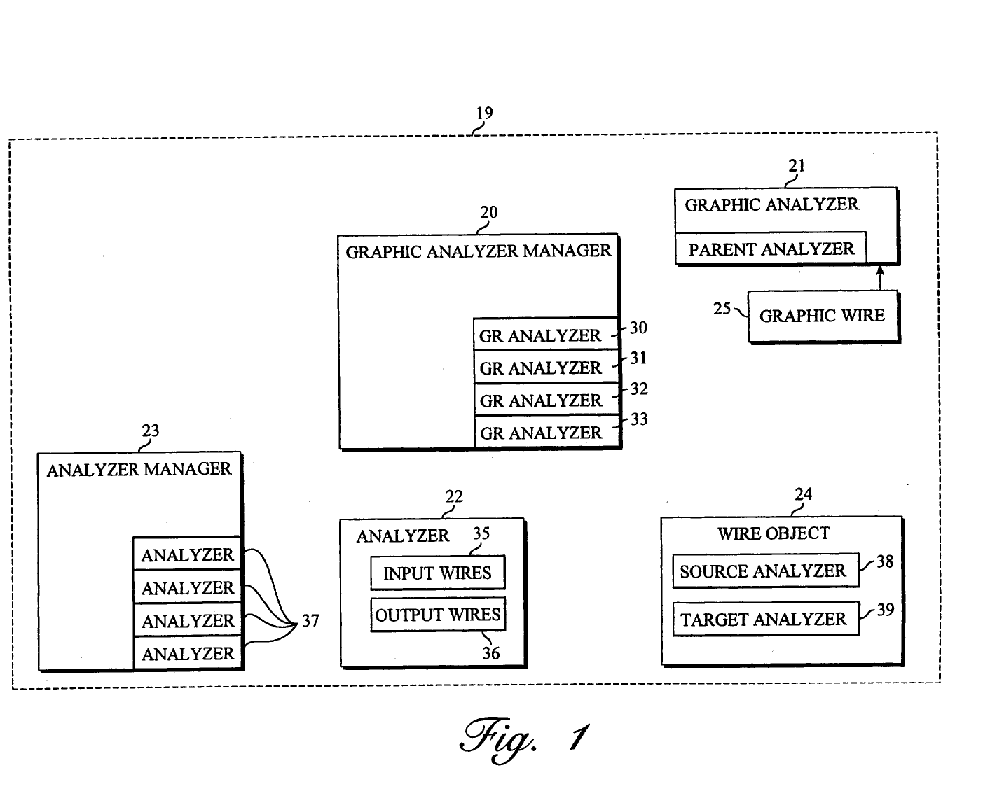

Referring now to FIG. 1, there is shown a block diagram of the architecture of a generalized wiring system 19 for a data flow functional coverage tool, according to the present invention. The wiring system 19 is used in the graphical user interface 3 to implement a data flow functional coverage tool according to the present invention, which is conveniently capable of adaptation or modification according to the needs of the design test engineer. The wiring system 19 includes the following objects which are part of the architecture of the present invention. In particular, the wiring system 19 includes a graphic analyzer manager 20, a plurality of graphic analyzers 21, any number of analyzers 22, an analyzer manager 23, any number of wire objects 24, and any number of graphic wire objects 25. The graphic analyzer manager 23 includes a plurality of graphic analyzers 30-31. The graphic analyzer 21 includes a reference to a parent analyzer 34. The analyzer object 22 includes reference to a input wires 35 and output wires 36. The wire object 24 includes reference to a source analyzer 38 and a target analyzer 39. Analyzer objects 22 are the core of a functional coverage tool according to the present invention. The analyzer objects 22 perform the operations that execute specified coverage metrics on a selected event stream specified by a functional coverage tool. The graphic analyzer 21 is the representation of a selected analyzer object, that the user sees on a screen. Examples of analyzer objects are an event parser, a property analyzer, and a counter. The analyzer manager 23 maintains references to all analyzer objects currently being used, to describe a coverage metric. Further, the analyzer manager 23 provides common services that are required by all analyzers. The analyzer manager 23 is the object that facilitates and manages the wiring process overall. The graphic analyzer manager 20 maintains references to all graphic analyzers that correspond to the analyzer objects currently being used to describe a selected coverage metric. The graphic analyzer manager 20 determines which graphic analyzer has been clicked on by a user. Additionally, the graphic analyzer manager 20 initiates wiring activities according to the present invention. The wire object 24 is responsible for the actual wiring of first and second analyzers selected for interconnection. The wire object 24 maintains references to its source and target analyzers. The wiring system 19 of the present invention is built as an object-oriented framework. The interfaces between the objects described above define the wiring process according to the present invention. By descending classes from the base objects described here, (specifically, the analyzer and graphic analyzer base classes), the functional coverage tool can be expanded as required. All that is required of the descended classes is that they provide a common function call interface. The descended classes may perform different operations on the event object stream, and they can customize the wiring process in different manners via the hook functions provided in the wiring process. The wiring system according to the present invention is also modular. According to the present invention, wiring activity is isolated within the wire object. By modifying the wire object 24 according to the present invention, the system is reusable for other applications that are not related to the functional coverage application described herein. Thus, a GUI system 3 is provided for a functional coverage tool using a plurality of analyzer objects and a generalized wiring mechanism, which allows a user to operatively interconnect selected analyzer components together in order to operate a user-friendly GUI functional coverage tool according to the present invention.

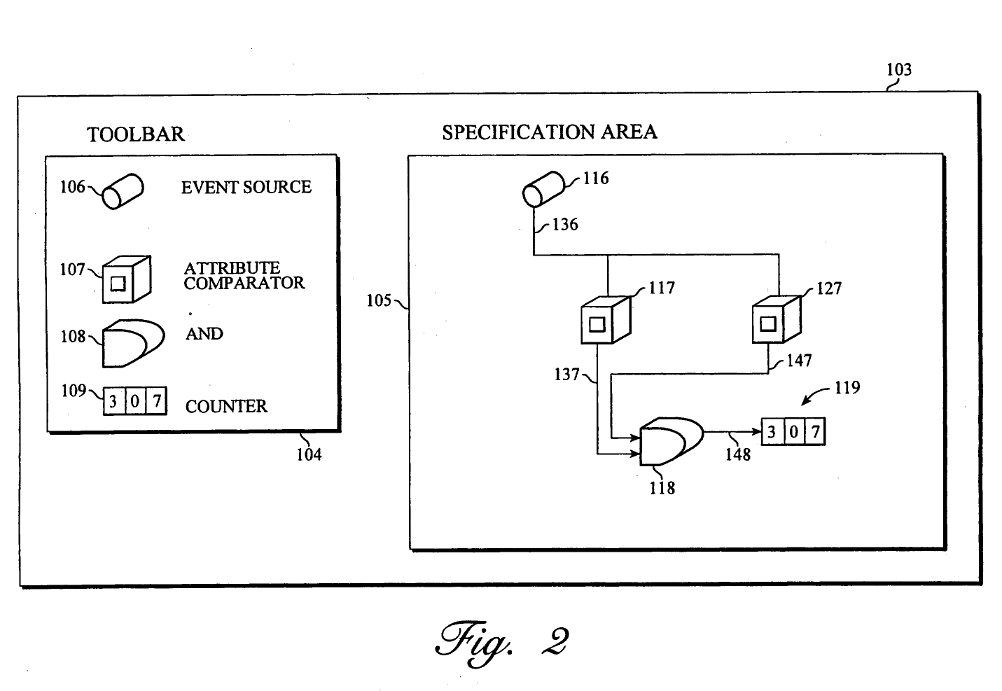

Referring now to FIG. 2, there is shown a block diagram of a graphical user interface 103 including a toolbar 104 and a specification area 105, according to one embodiment of the present invention. The toolbar 104 includes a plurality of elements for use in connection with the present invention, including but not limited to an event source 106, an attribute comparator 107, an AND gate 108, and a multi-digit counter 109. The specification area 105 of the graphical user interface 103 includes particular instances of an event source 116, first and second attribute comparators 117 and 127, an AND gate 118, and a counter 119. These instances are interconnected according to one embodiment of the present invention, as described below. In particular, the event source instance 116 and the first and second attribute comparator instances 117 and 127 are linked with each other by a graphic wire 136. Further, first and second attribute comparator instances 117 and 127 are linked with graphic wires 137 and 147 to the AND instance 118, which in turn is linked by a graphic wire 148 to three-digit counter instance 119. In the example shown, the user has chosen an event type for creation of a specific event source 116 that detects exclusively a particular kind of event. The output of the event source 116 is furthermore fed to the input of respective first and second attribute comparators, 117 and 127. These attribute comparators 117, 127 are configured, according to one embodiment of the present invention, to detect events having particular attributes that are equal to a user-specified value. Each of the attribute comparators 117, 127 is attached at its output connection to a common logical AND gate 118 at corresponding ones of its inputs. According to one embodiment of the present invention, an event is detected having attributes which satisfy the restrictions established by the first and second attribute comparators 117, 127. When such an event is detected, the AND gate 118 passes the event object to the counter object 118, causing the counter 118 to increment its count. Thus, according to the present invention, the user is able to determine the number of events detected which have attributes satisfying the particular user-defined coverage metric which is of interest.

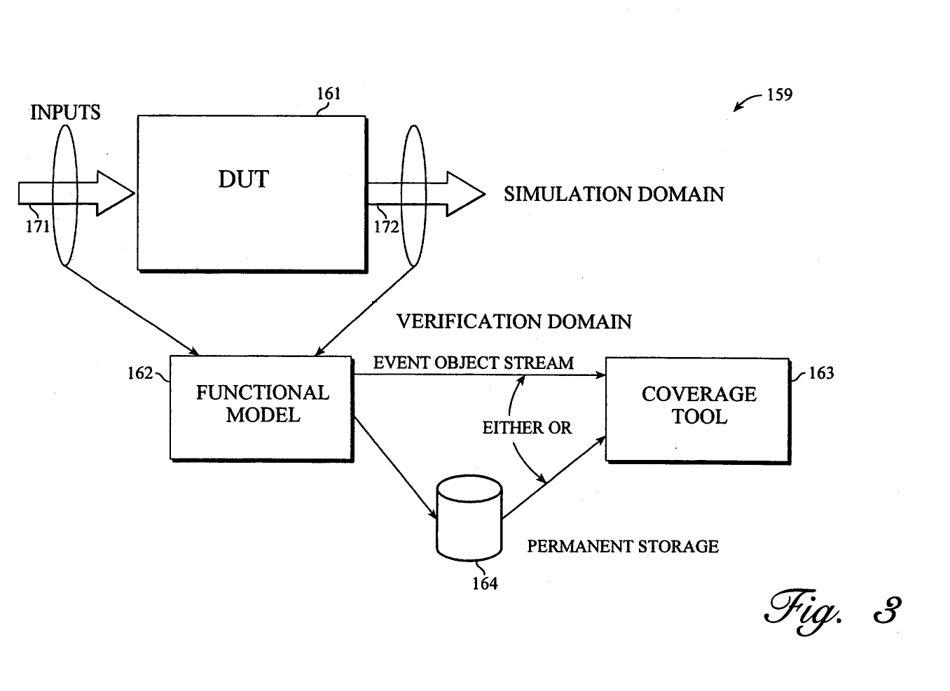

FIG. 3 is a block diagram of a particular test environment 159 according to the present invention. The test environment includes a coverage tool 163 in a selected verification environment, according to one embodiment of the present invention. In particular, the test environment 159 includes a selected device under test (DUT) 161, a functional model 162 of the DUT 161, a coverage tool 163 designed to evaluate the DUT 161 based upon evaluations performed with the functional model 162, and a storage structure 164 connected to communicate with the functional model 164 and the coverage tool 163. The DUT 161 is particularly configured to have respective inputs 171 and outputs 172 for operation in a simulation domain, according to the present invention. The functional model 162 is further connected to the coverage tool 163 to enable reception of an event object stream, and the storage structure 164 is in turn also connected to the coverage tool 163, in a verification domain. An event object stream passes from the functional model 162 to a selected coverage tool 163 according to the present invention. The coverage tool 163 is able to receive event objects in a stream from the functional model 162 or from event objects from storage structure 164, according to the present invention. The functional model 162 particularly receives information from inputs 171 and outputs 172, which are disposed in the simulation domain. In this manner, the relationship of the coverage tool to the verification environment is set forth clearly and explicitly. Thus, a functional model of the DUT 161 is established for functional verification and is able to communicate the outputs and inputs of the DUT 161 in simulation. The functional model 162 provides for creation of an output stream of event objects, as it detects different events occurring in the DUT 161. This stream of event objects from the functional model 162 is used by the coverage tool 163 to analyze the completeness of particular tests being simulated. The stream of events from the DUT 161 is fed directly to the coverage tool, according to one embodiment of the present invention. However, according to another embodiment, the event object stream from the DUT 161 is provided not immediately, but at a later time to the coverage tool 163, after the event objects have first been serialized into a storage location 164. Then, at a later time, the event objects are reconstructed in a stream for transportation to the coverage tool, for subsequent processing by the coverage tool at a later time when it is desired to be done, by the user.

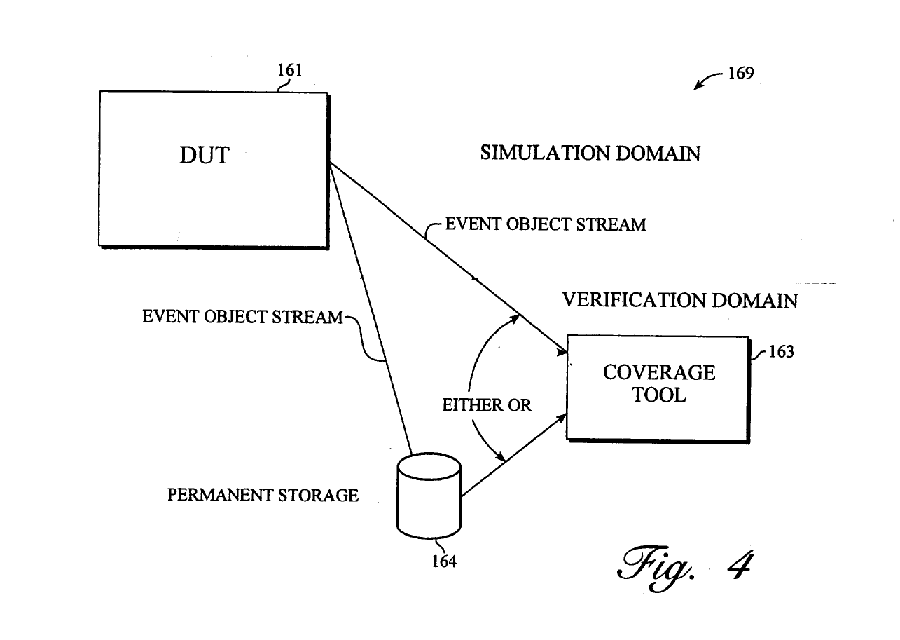

FIG. 4 is a block diagram of a test environment 169 having a selected device under test (DUT) 161 within a simulation domain, and further including a coverage tool 163 and a storage mechanism 164 in a verification environment in communication with the simulation domain, according to another embodiment of the present invention. In particular, the test environment 169 includes the DUT 161, a coverage tool 163 receiving elements of an event object stream from the DUT 161, and a storage structure 164 configured to receive elements of an event object stream from the DUT 161. Further, the DUT 161 is directly connected at its output to the coverage tool 163 and the storage structure 164, but the coverage tool 163 is configured to receive events from either one or the other, but not from both of the event object stream sources, i.e., the DUT 161 and the storage structure 164. In particular, storage structure 164 is connected to the coverage tool 163 to provide event objects from storage to the coverage tool, in a verification domain. An event object stream flows from the DUT 161 to the coverage tool 163. Moreover, the coverage tool 163 either receives event objects from the DUT 161, or it receives event objects from storage structure 164, according to the present invention. In this manner, the role of the coverage tool 163 to the verification environment is set forth clearly. The stream of event objects originating from the DUT 161 is used by selected coverage tools to permit analysis of the coverage and completeness of particular tests being simulated. The stream of events from the DUT 161 is accordingly fed directly to the coverage tool 163, according to one embodiment of the present invention. According to another embodiment, the stream of event objects is provided at a later time after the events have first been serialized at a selected storage location, to enable reading of the objects by the coverage tool 163 at a later time. According to this embodiment of the present invention, the HDL code has been instrumented to create event objects directly.

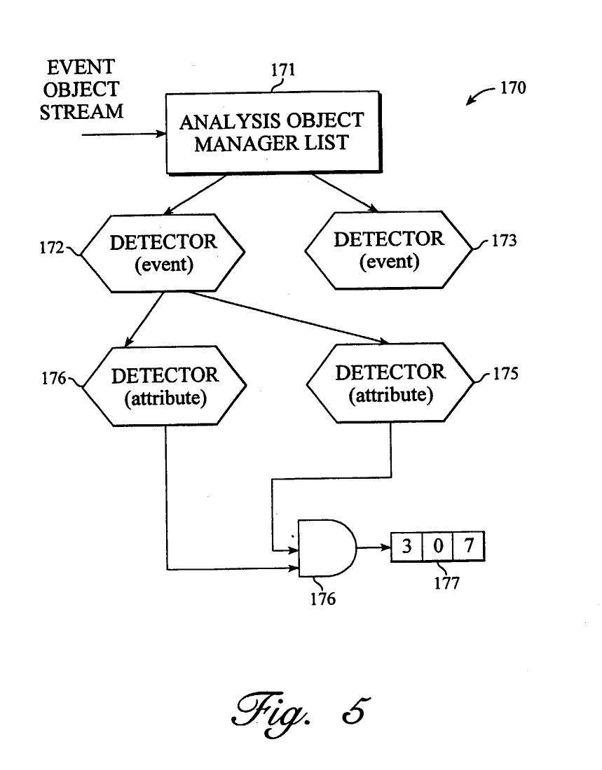

FIG. 5 is a data flow diagram describing operation of a coverage tool method 170 according to one embodiment of the present invention. In particular, the coverage tool method 170 according to the present invention includes receipt of an event object stream by an analysis object manager 171 which is configured to communicate elements of an event object stream to at least one of a plurality of event analyzers 172-175, i.e., first through fourth event analyzers, either directly or indirectly. According to one embodiment of the present invention, the output of a first event analyzer 172 is connected to the input of second and third event analyzers, respectively 174 and 175. Further, the outputs of second and third event analyzers 174, and 175, are provided to a AND gate 176 which is connected at its output to the input of a counter mechanism 177. The event objects of the event object stream according to the present invention are particularly fed into the analysis object manager 171 which in turn feeds these event objects into each of its associated top level event analyzers, i.e., first and fourth event analyzers 172, 173. The top level event analyzers are responsible for searching for specific types of events and are called event sources. After detecting the correct event types according to predetermined criteria, these event sources pass the detected event objects down to one or more additional analysis objects, e.g., second and third event analyzers 174 and 175. These analysis objects 174, 175 in turn may be connected in any manner specified by the user to create composite coverage analysis objects. As shown, there are two additional analyzers, which are set-up to detect specific event attributes. Thus, when the analyzers sense the arrival of the specified attribute, they call a function in an attached AND block 176. If the AND block 176 receives both of the indicated function calls on either of its inputs, it calls an applicable function which is preconfigured to increment the attached counter object 177, as in indication for example of the level of coverage applied to a device under test.

An event object according to the present invention includes a predetermined code block. An event object also includes a data block which includes an attribute array sub-block. The block code of an event object is used to specify which portion of the design a particular event is from in a selected devices under test (DUT), where one type of event is detected in more than one block of a circuit in a DUT. For example, a particular device under test may include first and second independent serial ports for external input of data or signals. Because the serial ports of the DUT are in this case identical, the events being monitored for the indicated serial ports are substantially identical. If the user wishes to specify independent coverage metrics for each of the two ports, but not for both of the ports, particular block codes enable user specification of each applicable serial port. The event code is thus used to distinguish particular types of events from each other, such as for example read bus cycle events, write bus cycle events, and interrupt events, from each other. The attribute array thus contains applicable information for a range of particular event attributes, such as for example without limitation time of occurrence, bus cycle address, or interrupt vector number, as the case may be. The structure of such event objects is generic, and this enables description of substantially all device events of interest. The event objects can moreover be serialized for persistent storage according to the present invention, to enable post-simulation coverage analysis. An interface is provided according to the present invention that permits user query of event type for information about the name of the event, the source block of the event, and the available attributes of the event, as desired. According to the present invention, the user uses this interface to determine what information is available for a particular device under test, to create coverage metrics. According to one embodiment of the present invention, English language descriptions of event objects are stored in a discrete object called an EventInfo object. Such event objects are stored in the EventInfo object using numeric codes that reference various English description tables which are stored in the EventInfo object. However, the storage intensive English language descriptions are stored only once in a coverage tool, and the event objects contain only compact numeric codes. Thus, storage space is considerably reduced with the present invention.

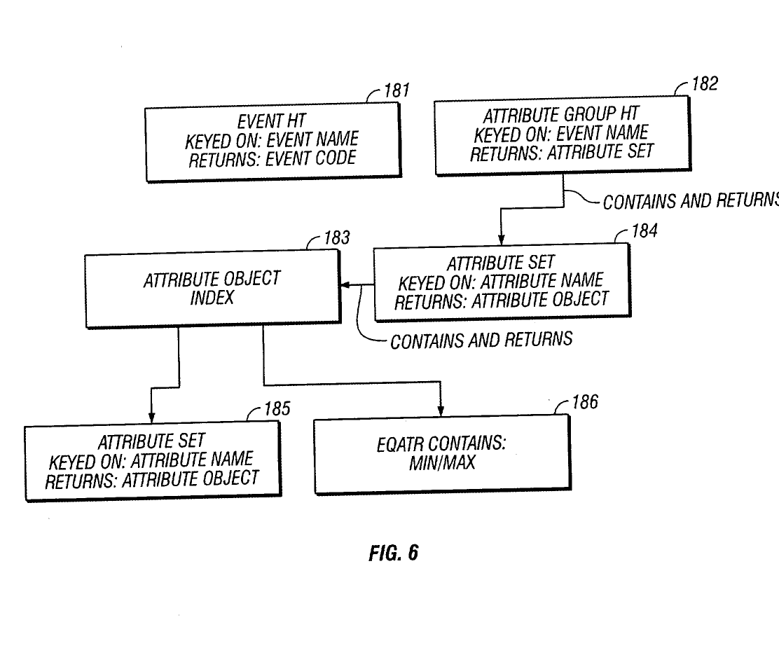

FIG. 6 is a block diagram of an EventInfo object architecture 180 according to the present invention. In particular, the event architecture 180 includes first through sixth objects 181-186. At the top level of the EventInfo object 180, there are first and second objects 181 and 182, respectively named EventHT and AttributeGroupHT. The first object 181 EventHT is an event hashtable having the label EventHT. The EventHT hashtable particularly holds the names of events that are detectable in the device under test, as well as containing associated event numberic codes for each detectable event name. The second object 182 is a hashtable labled as the AttributeGroupHT. This object AttributeGroupHT is keyed by a given event object's English name. The AttributeGroupHT contains one hashtable for each event that has one or more aattributes and can be detected by the device under test. The contained hashtables are called AtributeSets and contain English language descriptions of the attributes described by particular event objects. The AttibuteSet hashtable is subject to query for lists of English names of attributes corresponding to particular event objects. The attribute object 183 contains three pieces of information about each attribute, according to one embodiment of the present invention. As a first piece of information, the attribute object 183 returns an index that the given attribute's value is located at in the event objects's attribute array. Second, in the case of attributes that are not numerically described, e.g., the serial input port source described below, the Attribute object holds a hashtable that relates the English description of an attribute's possible values to the numeric codes used to store each possible value in the event object. Finally, in the event of attributes that are numerically representable, the Attribute object contains minimum and maximum allowed values for the particular attribute. The table below demonstrates the utility of the English language translation functionality according to the present invention, in terms of an attribute value coding example. According to this example, an audio serial input port takes an input from several different sources, based upon device settings with particular variable settings as shown in the table indicated. The user specifies the sources for which coverage metrics are desired, according to one embodiment of the present invention. Each communcation cycle that travels through the serial input port is effective for causing an event object to be created and to be serialized to storage. To conserve space in storage, the attribute value is stored as a number shown in the second column. Allowing the user to chose the numbers is useless according to the present invention, but by query of the EventInfo object, the user generates event object names in English definition form, enabling intelligent choices.

| Serial Port Source | Numeric Code |
|---|---|
| Compressed Data Interface | 0 |
| Digital Audio Interface | 1 |
| S/PDIF | 2 |

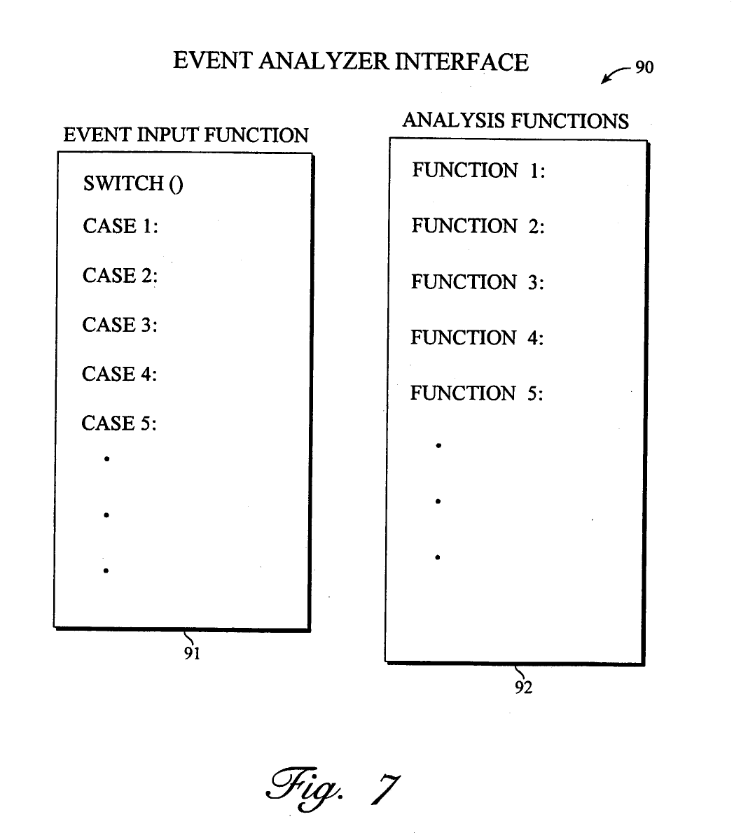

FIG. 7 is a block diagram of the input structure of an analysis object 90 used to define coverage metrics to be executed on the event object stream created by a given simulation or set of simulations, according to one embodiment of the present invention. The analysis object 90 has a multiple input mapping interface between first and second function groups respectively 91 and 92. The first function group includes a single function, which is an EventInput function, and the second function group 92 includes a plurality of analysis functions. The EventInput Function includes a switch function( ) and a plurality of numbered cases corresponding to ordered ones of the analysis functions in the second function group 92. Analysis objects receive event objects as inputs. Operations are performed according to the present invention using the event codes and attribute values of the event objects. Dependent on the results of a particular operation, the event objects are either dropped, passed downstream to additional analysis objects, or a display is updated indicating the result of analysis. Event objects are passed to analysis objects using an interface configured according to the present invention. In particular, the event object itself and an associated numeric code are passed to the analysis object. A function “EventInput” exists in each analysis object, according to one embodiment of the present invention. According to yet another embodiment of the present invention, an arbitrary number of inputs are added to an analysis object at run-time by using a dynamic data structure that allocates additional storage for each input. Further, each input can be operated on in a similar fashion by looping the inputs. This type of mapping arrangement facilitates building of analysis objects with multi-inputs, such as such as AND or OR logical gates or structures, for example.

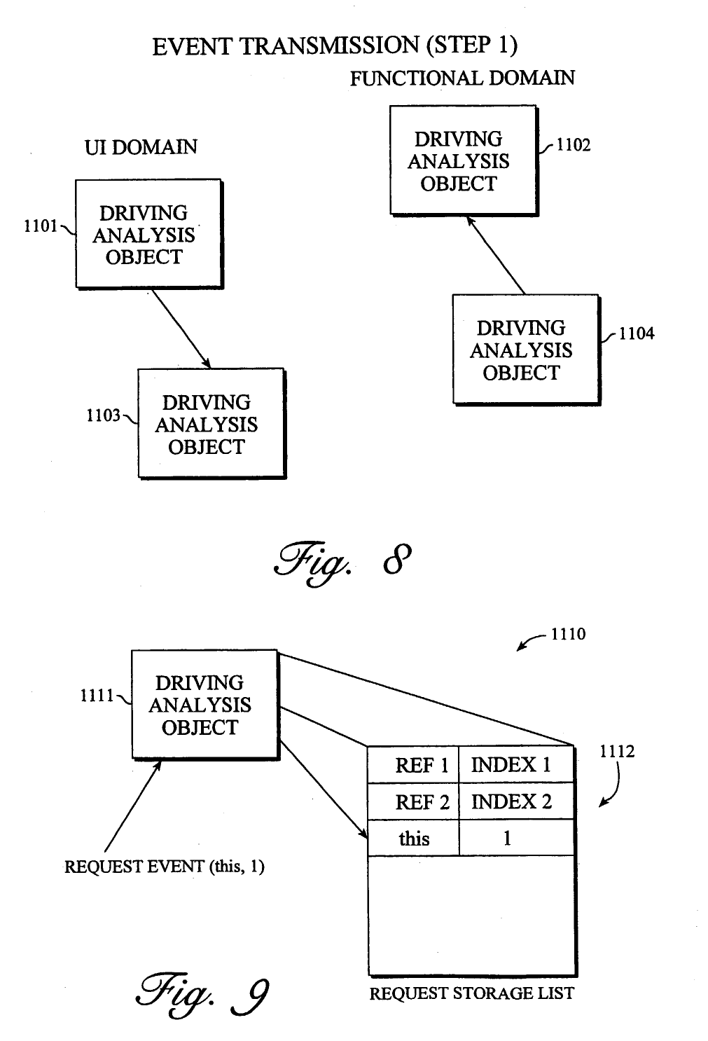

FIG. 8 is a diagram of a registration step of event transmission 1100 according to the present invention, operating in first and second domains, a user interface domain and an associated functional domain. As the user sets up each analysis object, the outputs of analysis objects are effective to drive the inputs of other objects as specified. According to the present invention, the driven analysis object internally passes an input index to the driving analysis object. More particularly, event transmission 1100 includes operation of first and second objects respectively 1101 and 1103 in the user interface domain, and first and second objects respectively 1102 and 1104 operating in the functional domain. Objects 1101 and 1102 are the driving analysis objects and objects 1103 and 1104 are the driven analysis objects. In the user interface domain, the user draws a connection from the driving to the driven analysis objects respectively 1101 and 1103. In the functional domain, the driven analysis object 1104 sends a message RequestEvent(this,1); to the driving analysis object 1102.

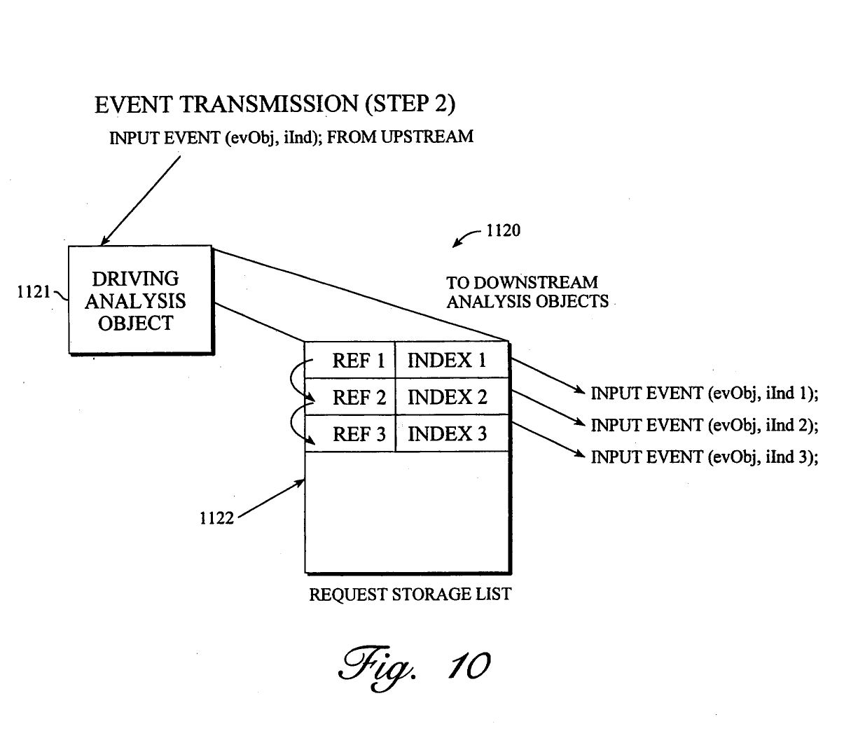

FIG. 9 is a diagram of a request storage step of event transmission 1110 according to the present invention. In particular, event transmission 110 includes first and second objects respectively 1111 and 1112. Object 1101 is the driving analysis object which references an associated request storage list in object 1112. In the functional domain, the driving analysis object 1111 responds to a message RequestEvent(this,1). The message is sent to the driving analysis object 1102, and this causes it to request storage in object 1112. Object 1112 contains previous references, ref1 associated with index1, and ref2 associated with index2, as well as reference “this” associated with “1”.

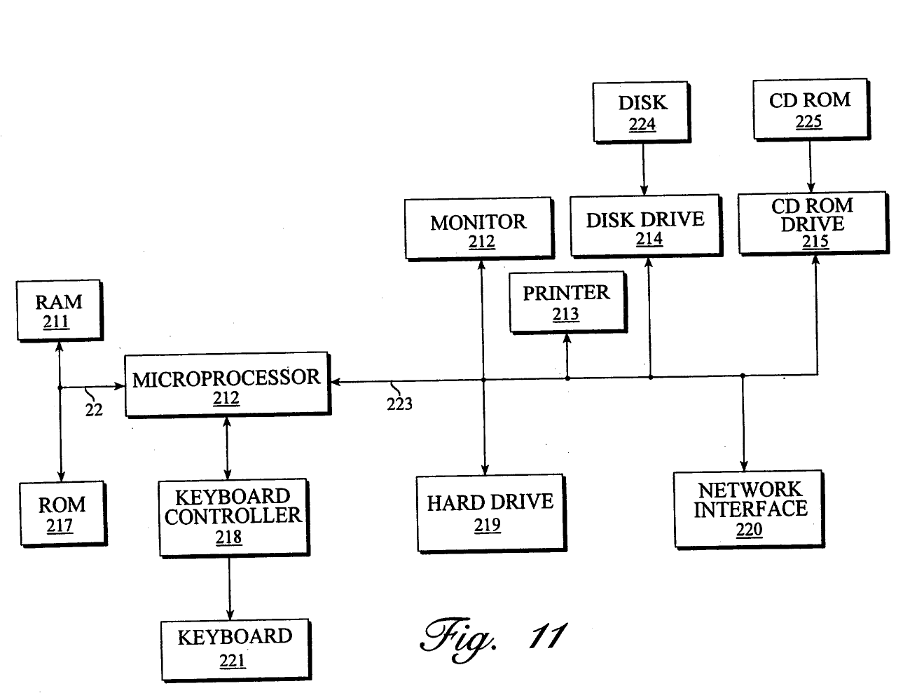

FIG. 10 is a diagram of an event object transmission step with respect to event transmission operation 1120 according to the present invention. In particular, event transmission operation 1120 includes. first and second objects respectively 1121 and 1122. Object 1121 is the driving analysis object referencing a request storage list in object 1122. In the functional domain, the driving analysis object 1121 responds to a message InputEvent(evObj,iInd) from upstream. The message is sent to the driving analysis object 1122, which upon receipt causes it to request storage in object 1122. Object 1122 contains multiple references, ref1 associated with index1, ref2 associated with index2, as well as ref3 associated with Index3. The object 1122 produces messages to downstream analysis objects for example, InputEvent(evObj,iInd1), InputEvent(evObj,iInd2), and InputEvent(evObj,iInd3). The driving object uses this index when calling the EventInput function on the driving analysis object. The driving analysis object stores this index and a pointer or reference to the driven analysis object in a list. When the driving analysis object receives an event object, it first performs operations using the event object's event code and attribute values, to determine whether the event object should be passed downstream. If the event object is to be passed downstream to further driven analysis objects, then the current analysis object calls the EventInput function of every analysis object stored in its list. The driving analysis object passes both the event object and the requested input index stored, when the driven analysis objects are attached.

FIG. 11 is a block diagram of a computer system for implementing operation of a computer program product according to the present invention. In particular, the computer system 210 which implements the computer program product according to the present invention includes a random access memory (RAM) 211, monitor 212, a printer 213, a disk drive 214, a compact disk (CD) read only memory (ROM) drive 215, a microprocessor 216, a read only memory (ROM) 217, a keyboard controller 218, a hard drive 219, a network interface 220, a keyboard 221, and first and second buses 222 and 223. First bus 222 connects microprocessor 216 with RAM 211 and ROM 217. Second bus 223 connects microprocessor 216 with monitor 212, printer 213, disk drive 214, CD ROM drive 215, hard drive 219, and network interface 220. Microprocessor 218 is additionally connected to a keyboard controller 218 which in turn is connected to a keyboard for communication with a user. Disk drive 214 is configured to read and write information with respect to a disk medium 224 on which the information is stored, and from which it can be read. CD ROM drive 215 is configured to read information with respect to a CD ROM medium 225 on which the information is stored, and from which it can be read. Computer program products according to the present invention can be embodied on the disk medium 224 or the CD ROM medium 225 or the like (such as an optical or magnetic disk, for example).

In summary, a functional coverage tool according to the present invention includes without limitation, an intuitive user interface that allows the user to specify coverage metrics in terms of objects that they are already familiar with,(e.g. logic gates, comparators, counters, histograms, for example without limitation). The tool is portable between different devices under test (i.e., DUTs). To port the tool, a file is created that describes the events fired by the DUT, and the tool reads in the file, yielding the benefit of portability. The tool further allows coverage metrics with respect to device configuration to be specified either before or after the simulation of the DUT is run. A unique treatment of DUT configuration changes allows this functionality. The tool uses event history files that are significantly smaller that those used by other tools, because of the aforementioned unique treatment of DUT configuration changes. The tool uses event history files that are significantly smaller that those used by other tools, because the functional events are stored as numeric values rather than text strings. The tool is easily expandable (in analyzers and presentation objects), without modification because the interface between analyzers is well defined. The tool allows users to specify coverage metrics after a simulation without rerunning the simulation, thus saving valuable simulation time.

What is claimed is:

1. A functional coverage tool comprising:
an analyzer manager configured to produce analyzers upon user request.

2. The functional coverage tool according to claim 1 further including graphical analyzer manager configured to communicate with the analyzer manager, to enable display of graphic analyzers.

3. The functional coverage tool according to claim 2 further including at least a single analyzer.

4. The functional coverage tool according to claim 2 further including at least a single graphic analyzer handling display functions for analyzers which have been created.

5. A method of constructing analyzers comprising:
engaging the analyzer manager with communication of an analyzer class name; and
using the class name to construct an analyzer of that class.

6. A method of constructing a wire object comprising:
constructing first and second analyzers,
creating wire objects to connect said first and second analyzers, and
passing references to enable attachment of the two analyzers to each other.

7. A graphical user interface (GUI) for expressing device under test coverage metrics based upon data flow, comprising:
an expression mechanism for at least a single presentation object which expresses the functionality of a selected device under test, said expression mechanism adapted for receipt of event objects; and
an expression mechanism for at least a single analysis object for operation with the expression mechanism for said at least a single presentation object, said expression mechanism adapted to enable the user to determine event object attributes with specification of coverage metrics subject to a selected combination of the event object's attributes.

8. The GUI according to claim 7 wherein said event objects are serialized into permanent storage, allowing the user to specify and execute new coverage metrics at any time after simulation.

9. The GUI according to claim 7 analysis objects are modeled to describe coverage metrics.

10. The GUI according to claim 7 including combination of event objects and analysis objects, permitting coverage metrics to be specified in a simple data flow manner.

11. The GUI according to claim 7 wherein said coverage metric permits the user to connect analysis objects together in a visual builder environment.

12. The GUI according to claim 7 wherein the user specifies desired coverage metrics, such as coverage of sequences of events and/or coverage of events that occur during the same time window of a simulation, using analysis objects.

13. The GUI according to claim 7 wherein the display functionality of the coverage tool is expandable because the presentation objects use the same event object interface as the analysis operator objects.

14. The GUI according to claim 7 wherein said coverage metrics are subject to specification either before or after device simulation events as object.

15. The GUI according to claim 7 wherein functional events in a device under test are configured as event objects, and event objects are passed to selected analysis tools chosen by the user, such as analyzers, logic gates, and coincidence counters.
